(19) United States
(12) Patent Application Publication
(10) Pub. No.: US 2017/0334046 A1
(43) Pub. Date: Nov. 23, 2017

(54) TORQUE-LIMITING AND RATCHETTING MECHANISM

(71) Applicant: Titan Dental Systems, LLC, San Antonio, TX (US)

(72) Inventors: Matthew A. Kaupp, San Antonio, TX (US); John Richard Stockton, JR., San Antonio, TX (US); Michael J. Crescenzo, San Antonio, TX (US)

(73) Assignee: Titan Dental Systems, LLC, San Antonio, TX (US)

(21) Appl. No.: 15/162,182

(22) Filed: May 23, 2016

(51) Int. Cl. B25B 23/142; B25B 23/14; B25B 13/46

(52) U.S. Cl. CPC B25B 23/1427; B25B 13/463; B25B 23/141

(57) ABSTRACT

Provided is an apparatus for applying a specific amount of torque, comprising a body, a torque wheel, rotationally affixed to the body, comprising a plurality of teeth around an outer edge and a central spring mechanism affixed to and enclosed within the body, the central spring mechanism, comprising a spring stop and a torque spring, the torque spring comprising a torque spring end wherein the torque spring end engages the plurality of teeth and wherein, in a first rotational direction, the engagement of the torque spring end in the plurality of teeth prevents the torque wheel from rotating with respect to the body below a specified amount of torque and wherein, above the specified amount of torque in a second rotational direction, the torque spring flexes enabling the torque spring end to disengage from the plurality of teeth and enabling the torque wheel to rotate with respect to the body.

### FIELD OF DISCLOSURE

The claimed subject matter relates generally to wrench and, more specifically to torque-limiting wrench that may include a ratcheting mechanism.

### BACKGROUND OF THE INVENTION

A torque wrench is a mechanism that enables the amount of turning and twisting force, or “torque,” applied to a fastener, such as a screw, bolt or nut, to be set to a fixed limit. Current torque wrenches are complicated and expensive devices that enable a user to dial in a selected amount of torque. Of course, the user must know the appropriate torque setting prior to use of the wrench. A “ratchet” is a wrench that enables torque to be applied in one direction, i.e., clockwise or counter-clockwise, to a fastener but rotates freely in the other direction without applying a significant amount torque, allowing the ratchet handle to be re-positioned for another turn while remaining attached to the fastener.

### SUMMARY

Provided is an apparatus for applying a set amount of torque to a fastener such as, but not limited to, a screw, nut or bolt. In addition, the disclosed mechanism may include a ratchet mechanism.

More specifically, provided is an apparatus for applying a specific amount of torque to a fastener, comprising a body, a torque wheel, rotationally affixed to the body, comprising a plurality of teeth around an outer edge and a central spring mechanism affixed to and enclosed within the body, the central spring mechanism, comprising a spring stop and a torque spring, the torque spring comprising a torque spring end wherein the torque spring end engages the plurality of teeth and wherein, in a first rotational direction, the engagement of the torque spring end in the plurality of teeth prevents the torque wheel from rotating with respect to the body below a specified amount of torque and wherein, above the specified amount of torque in a second rotational direction that is the opposite of the first rotational direction, the torque spring flexes between the spring stop and a point at which the torque spring attaches to a remainder of the central spring mechanism, enabling the torque spring end to disengage from the plurality of teeth and enabling the torque wheel to rotate with respect to the body.

The apparatus may also include a ratchet mechanism. More specifically, also provided are a ratchet wheel, rotationally affixed to the body, the ratchet wheel comprising a second plurality of teeth around a second outer edge and a ratchet spring and the central spring mechanism, further comprising a ratchet spring comprising a ratchet spring end wherein the ratchet spring end engages the second plurality of teeth; wherein, in a third rotational direction, the engagement of the ratchet spring end in the second plurality of teeth prevents the ratchet wheel from rotating with respect to the body; and wherein, in a fourth rotational direction that is the opposite of the third rotational direction, the ratchet spring flexes, enabling the ratchet spring end to disengage from the second plurality of teeth and enabling the ratchet wheel to rotate with respect to the body.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is an illustration of a top view of a torque-limiting and ratcheting mechanism, or “torque wrench,” that exemplifies the claimed subject matter.

FIG. 2 is a view of the bottom of the torque wrench introduced in FIG. 1.

FIG. 3 is a perspective view of the top of the torque wrench shown in FIGS. 1 and 2.

FIG. 4 is an illustration of one embodiment of an central spring mechanism of the torque wrench of FIGS. 1-3.

FIG. 5 is an illustration of the central spring mechanism of FIG. 4 mounted in a body of the torque wrench of FIGS. 1-3.

FIG. 6 is an illustration a ratchet end of the wrench of FIGS. 1-3 while the wrench is employed to tighten a fastener.

FIG. 7 is an illustration the ratchet end of FIG. 6 while the wrench is ratcheting while employed to tighten a fastener.

FIG. 8 is an illustration a torque end of the wrench of FIGS. 1-3 while the wrench is employed to tighten a fastener with a specific torque.

FIG. 9 is an illustration the torque end of FIG. 8 while the wrench is ratcheting while employed to tighten a fastener with a specific torque.

FIG. 10 is an illustration of a second embodiment of an internal mechanism that may implement the torque wrench of FIGS. 1-3.

FIG. 11 shows an alternative embodiment of the torque wrench of FIGS. 1-3 unassembled, i.e., an exploded view.

### DETAILED DESCRIPTION

As the Inventors herein have realized, typical torque wrenches are complicated, expensive and therefore not particular conducive to single operation, non-reusability. Although wrench of the disclosed technology may be constructed for repeated use, the wrench may also be manufactured with methods and materials in a manner that enables it to be a single use item.

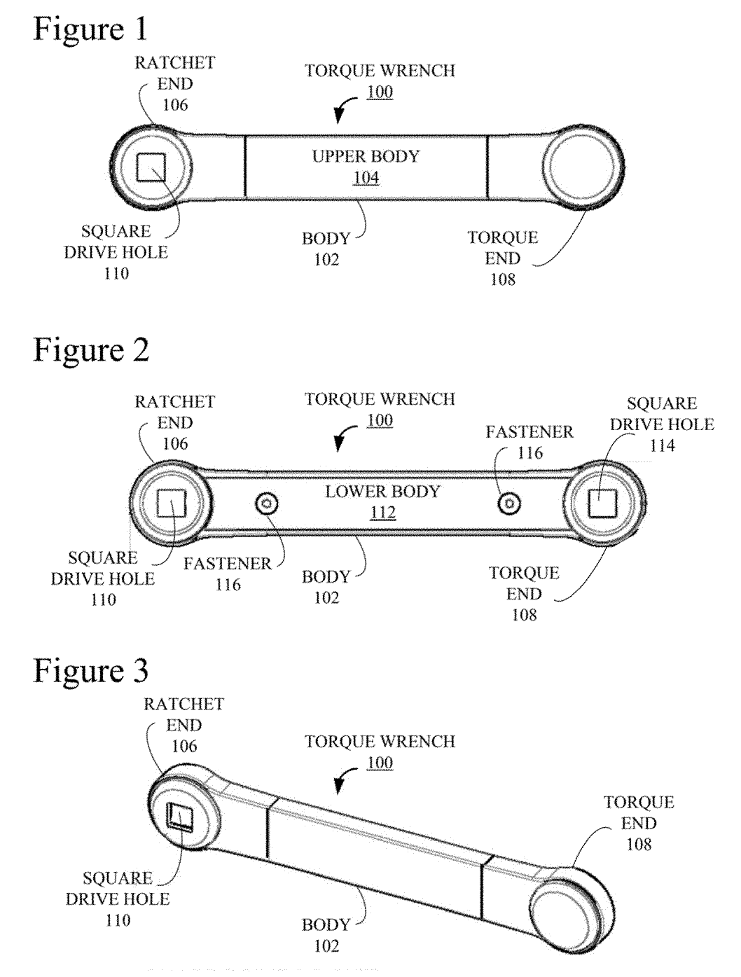

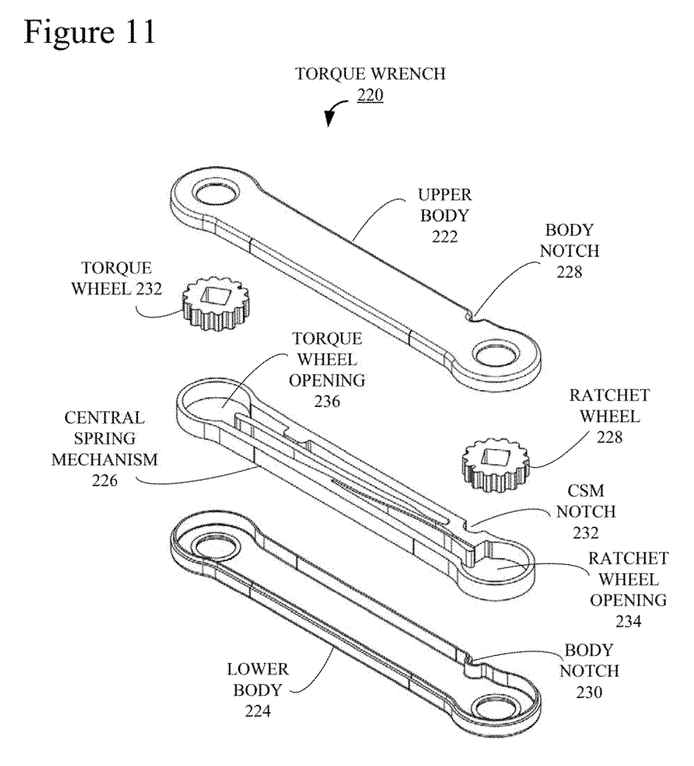

FIG. 1 is an illustration of a top view of a torque-limiting and ratcheting mechanism, or “torque wrench,” 100 that exemplifies the claimed subject matter. The components of the claimed torque wrench may be constructed of metal or plastic or any suitable material. Wrench 100 is encased in a body 102, of which an upper body 104 is visible in FIG. 1. Body 102 would typically be a combination of upper body 104 and a lower body (see 112, FIG. 2; 222 and 224, FIG. 11). Wrench 100 includes a ratchet end 106 and a torque end 108. As described in more detail in conjunction with FIGS. 2-5, ratchet end 106 is employed to tighten and untighten screws, bolts and other fasteners with torque limited by the strength and flexibility of the materials used in construction of wrench 100. Torque end 108 is configured to apply a pre-set maximum amount of torque during tightening of a screw, bolt or other type of fastener.

Visible in ratchet end 106 is a square drive hole 110. Square drive hole 110 may be employed to couple wrench 100 with square headed screws, bolts and other types of fasteners (not shown). It should be understood that other types of fasteners may also be tightened or untightened with ratchet end 106 of wrench 100 by using a different type of hole rather than square drive hole 110. For example, a six-sided hole (not shown) may be employed in conjunction with a typical six-sided bolt head or a star-shaped hole (not shown) may be employed with a star-shaped fastener head.

FIG. 2 is a view of the bottom of torque wrench 100 introduced in FIG. 1. FIG. 2 shows a lower body 112 of body 102 in addition to ratchet end 106, torque end 108 and square drive hole 110, all first introduced in FIG. 1. In addition, a square drive hole 114 in torque end 108 is visible. Like square drive hole 110, square drive hole 114 may be reconfigured to enable wrench 100 to tighten various types of fasteners with different types of heads. Is should be noted that, in this particular configuration, square drive hole 110 is illustrated as passing through body 102 while square drive hole 114 may only be placed around a fastener through lower body 112. In other words, in this embodiment, square drive hole 114 does not pass through upper body 104. In this configuration, ratchet end 106 may be employed to both tighten and untighten a fastener while torque end 108 is employed only to tighten a fastener with the appropriate torque.

Two fasteners 116 hold upper body 104 (FIG. 1) and lower body 112 together. Many different types of fasteners may be employed to hold upper body 104 and lower body 112 together including, but not limited to, bolts, screws and rivets. Further, upper body 104 and lower body 112 may simply be glued together or constructed in such a manner that they may be snapped together. The exact nature of the manner in which upper body 104 and lower body 112 are coupled is not relevant to the claimed subject matter.

FIG. 3 is merely a perspective view of the top of torque wrench 100 shown in FIGS. 1 and 2. Included in FIG. 3 are body 102, ratchet end 106, torque end 108 and square drive hole 110.

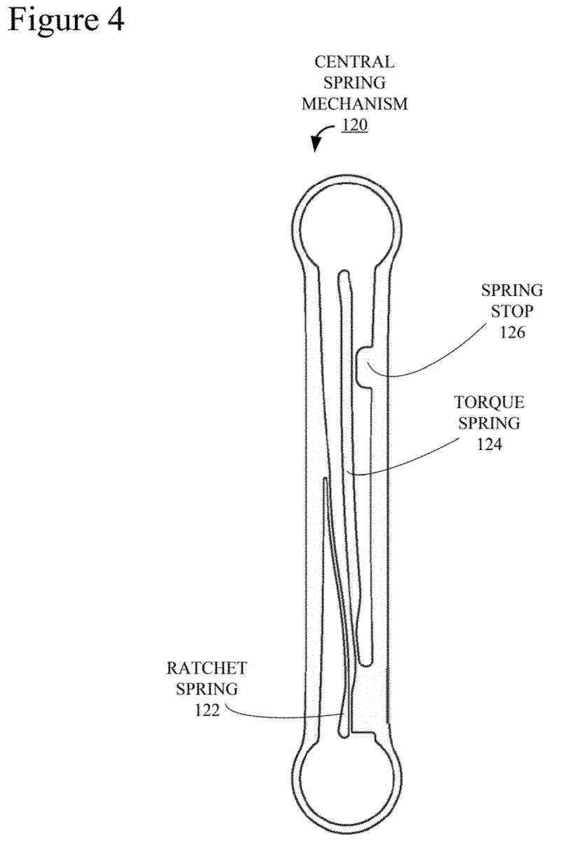

FIG. 4 is an illustration of one embodiment of an central spring mechanism 120 of torque wrench 100 of FIGS. 1-3. Central spring mechanism 120 includes a ratchet spring 122, a torque spring 124 and a spring stop 126.

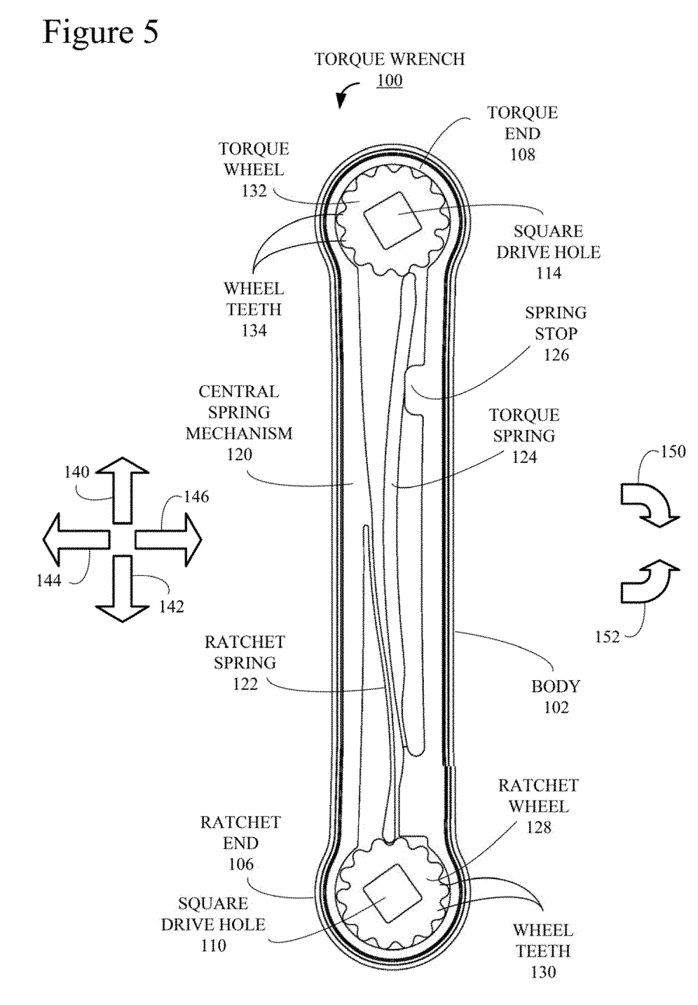

FIG. 5 is an illustration of a cut away view of body 102 (FIGS. 1-3) of torque wrench 100 of FIGS. 1-3, including central spring mechanism 120 of FIG. 4. As explained in FIG. 4, central spring mechanism 120 includes ratchet spring 122, which is oriented towards ratchet end 106 (FIGS. 1-3) and torque spring 124, which is oriented towards torque end 108 (FIGS. 1-3). At ratchet end 106 is a ratchet wheel 128 with a square drive hole 110 (FIGS. 1-3) and wheel teeth 130. At torque end 108, is a torque wheel 132, square drive hole 114 (FIG. 2) and wheel teeth 134. The operations of the various elements of FIG. 5 are explained in more detail below in conjunction with FIGS. 5-10.

Also included in FIG. 5 for purposes of explanation, are directional arrows 140, 142, 144 and 146 and rotational arrows 105 and 152. Throughout the Specification, arrow 140 will be referred to as the “up,” 142 as “down,” arrow 144 as “left” and arrow 146 as “right.” Rotation arrow 150 will be referred to as “counter-clockwise” and rotation arrow 152 as “clockwise.” Of course each of these direction designations is dependent upon the specific orientation of wrench 100 but will be used with respect to the orientation of wrench 100 shown in FIG. 5.

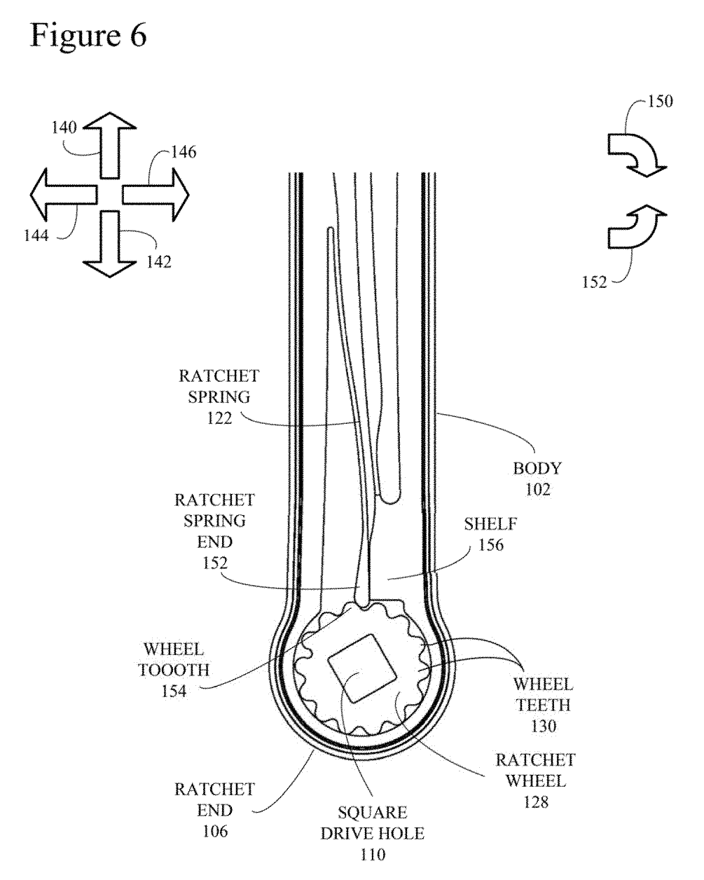

FIG. 6 is an illustration of ratchet end 106 (FIGS. 1-4) of wrench 100 (FIGS. 1-3) while wrench is employed to tighten a fastener (not shown) positioned in square drive hole 116 (FIGS. 1-3), i.e. when body 102 is being rotated clockwise 150. In this example, a fastener (not shown) through square drive hole 110 is exerting a clockwise 150 force on ratchet wheel 128. Ratchet spring end 152 is thereby pushed right 146 by a wheel tooth 154 of wheel teeth 130, forcing ratchet spring 122 against a shelf 156 of central spring mechanism 120. Shelf 156 then prevents ratchet wheel 128 from rotating counter-clockwise 152 respect to body 102, thereby enabling the fastener positioned in square drive hole 110 to be tightened.

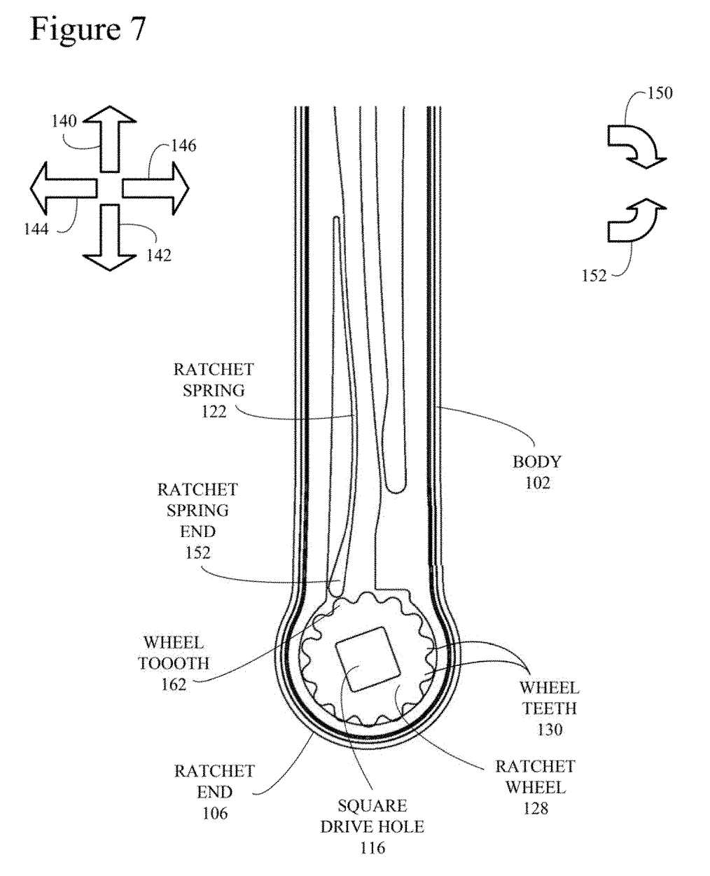

FIG. 7 is an illustration the ratchet end of FIG. 5 while wrench 100 is ratcheting while employed to tighten a fastener (not shown) positioned in square drive hole 110, i.e. when body 102 is being rotated counter-clockwise 152. In this example, a fastener (not shown) through square drive hole 110 is exerting a counter-clockwise 152 force on ratchet wheel 128. Ratchet spring end 152 is thereby pushed left 144 by a wheel tooth 162 of wheel teeth 130, forcing ratchet spring 122 to bend and enabling wheel teeth 130, including a wheel tooth 162, to clear ratchet spring end 152. This enables ratchet wheel 128 to rotate clockwise 150 with respect to body 102 and body 102 to be repositioned with respect to the fastener positioned in square drive hole 110, or “ratcheted,” without exerting sufficient torque on the fastener to untighten the fastener.

It should be understood that because square drive hole 110 passes through body 102 (see FIGS. 1-3) that the tightening/untightening of ratchet end 106 can be reversed by flipping wrench 100. In other words, if the fastener is started through square drive hole 110 through lower body 112 (FIG. 2) of body 102, wrench performs as described in FIGS. 6 and 7. However, if the fastener is started through square drive hole 110 through upper cover 102 (FIGS. 1 and 3), then wrench ratchets clockwise 150 and untightens the fastener counter-clockwise 152.

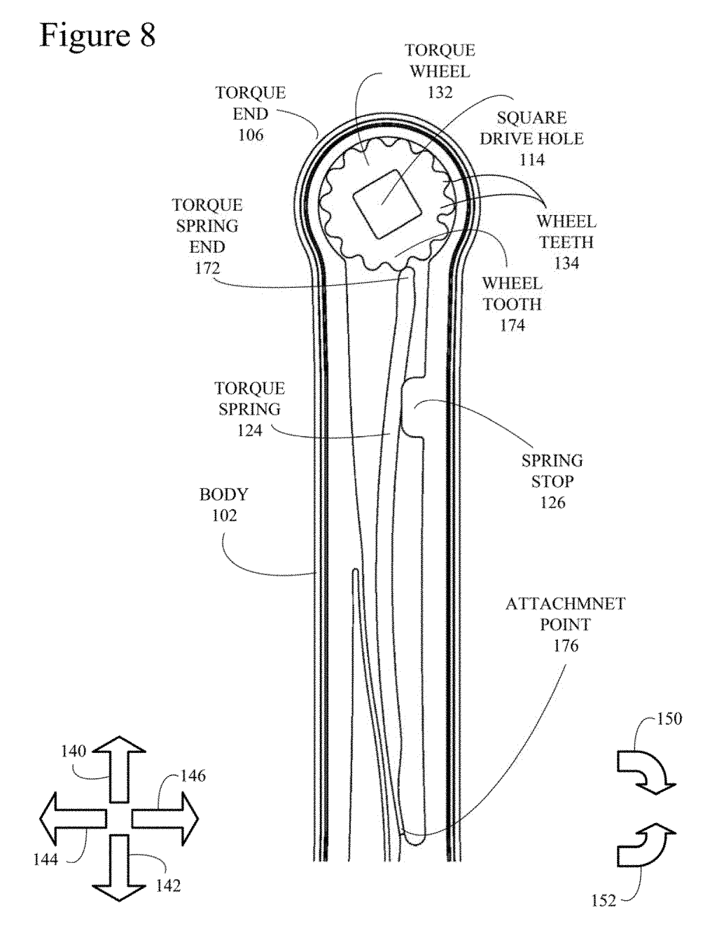

FIG. 8 is an illustration a torque end of the wrench of FIGS. 1-3 while the wrench is employed to tighten a fastener with to a specific torque, i.e., when body 102 is being rotated clockwise 150. Like in the example of FIG. 6, in this example, a fastener (not shown) through square drive hole 114 is exerting a counter-clockwise 152 force on torque wheel 132. A torque spring end 172 is thereby pushed right 146 by a wheel tooth 174 of wheel teeth 134, forcing torque spring 124 against spring stop 126 of central spring mechanism 120. Spring stop 126 then prevents torque wheel 132 from rotating counter-clockwise 152 respect to body 102, thereby enabling the fastener positioned in square drive hole 114 to be tightened.

Unlike the relative position of shelf 156 and ratchet spring end 152 (FIG. 5), spring stop 174 makes contact with torque spring 124 further from torque spring end 172. This positioning enables torque spring 174 to flex between spring stop 174 and an attachment point 176 at which torque spring 124 attaches to the rest of central spring mechanism 120. This flex enables wheel teeth 134, including wheel tooth 172, to clear torque spring 124 when sufficient torque is applied to body 102. In this manner, a defined amount of torque can be applied to the fastener through square drive hole 114, depending upon the force required to sufficiently flex torque spring 124. The specific amount of torque necessary can be fixed depending upon the size of torque spring 124 and the properties of the materials employed in the construction of torque spring 124.

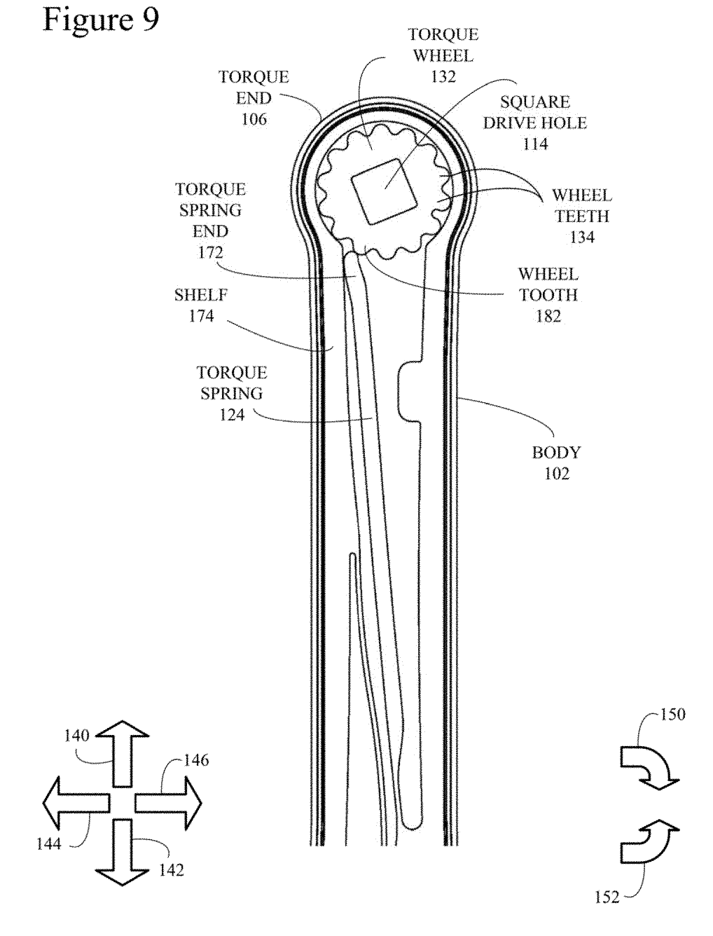

FIG. 9 is an illustration the torque end of FIG. 8 while the wrench is ratcheting while employed to tighten a fastener with a specific torque, i.e. when body 102 is being rotated counter-clockwise 152. Like in the example of FIG. 7, in this example, a fastener (not shown) through square drive hole 114 is exerting a counter-clockwise 152 force on torque wheel 132. Torque spring end 172 is thereby pushed left 144 by a wheel tooth 182 of wheel teeth 134, forcing torque spring 124 to bend and enabling wheel teeth 130, including wheel tooth 182, to clear torque spring end 172. This enables torque wheel 132 to rotate clockwise 150 with respect to body 102 and body 102 to be repositioned with respect to the fastener positioned in square drive hole 114, or “ratcheted,” without exerting sufficient torque on the fastener to untighten the fastener.

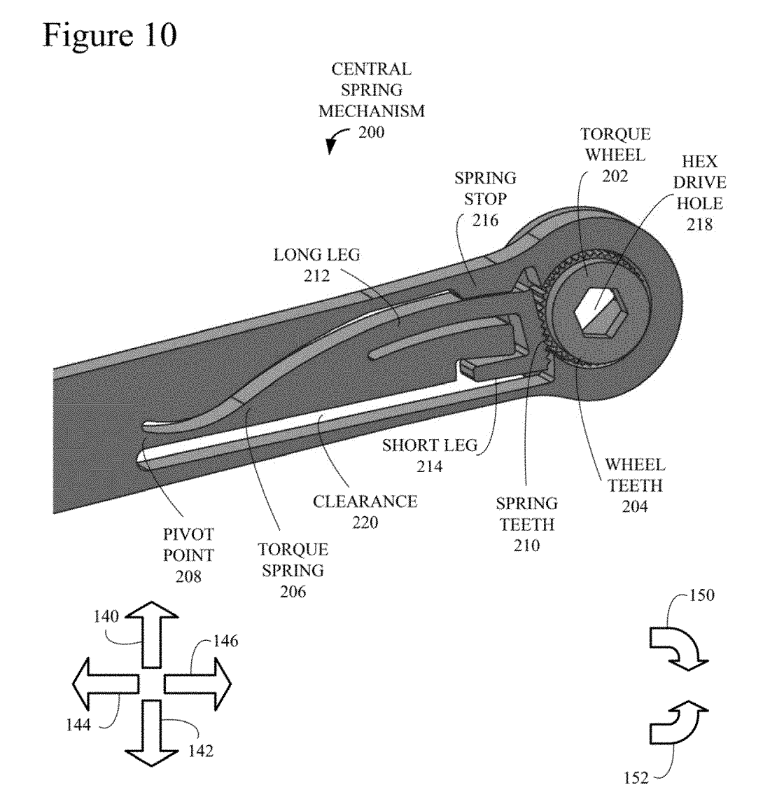

FIG. 10 is an illustration of a second embodiment 200 of a central spring mechanism that may be implemented with torque wrench 100 of FIGS. 1-3. Like FIGS. 5-9, direction arrows 140, 142, 144 and 146 and rotation arrows 150 and 152 are shown for the sake of convenience. Also illustrated with central spring mechanism 200 is a torque wheel 202 that includes a plurality of wheel teeth 204 along an outer edge and a hexagonal opening to accommodate, in the example, a hexagonal fastener to be tightened. A torque spring 206 attaches to the remainder of central spring mechanism 200 at a pivot point 208. Torque spring 206 is comprised of a spring teeth 210, a long leg 212 and a short leg 214. Central spring mechanism 200 is also comprised of a spring stop 216.

When body 102 (see FIGS. 1-3) is rotated in clockwise direction 150, long leg 212 is forced against spring stop 216, which enables torque wheel 202 to also turn in clockwise direction 150 with body 102 (see FIGS. 1-8). However, once a certain amount of torque is applied, torque spring 206 flexes between spring stop 216 and spring pivot 208, releasing spring teeth 210 from wheel teeth 204 and torque wheel 202 no longer rotates with body 102 and torque spring mechanism 200. In this manner, only a measured amount of torque is applied to a fastener through a hole in the center of torque wheel 202. A hex drive hole 218 in the center of torque wheel 202 conforms to the type of fastener that is to be tightened.

When body 102 (see FIGS. 1-8) is rotated in counter-clockwise direction 152, torque spring 206 is forced down 142 until short leg 214 has traveled through a clearance 220. This enables spring teeth 210 to become disengaged from wheel teeth 204, thereby enabling torque wheel 202 to rotate, or “ratchet.” with respect to body 102 and central spring mechanism 200.

FIG. 11 shows an alternative embodiment of a torque wrench, specifically a torque wrench 220, which is unassembled, i.e., an exploded view. Like torque wrench 100 (FIG. 1-3), torque wrench 220 includes a body like body 102 (FIGS. 1-3 and 5-9), which in this illustration is separated into an upper body 222 and a lower body 224, a ratchet wheel 228 like ratchet wheel 128 (FIGS. 5-7) and a torque wheel 232 like torque wheel 132 (FIGS. 5 and 8-10).

Unlike similar structures of torque wrench 100, upper body 222, lower body 224 and central spring mechanism 226 include a body notch 228, a body notch 230 and central spring mechanism (CSM) notch 232, respectively. Notches 228, 230 and 232 are intended to line up when torque wrench 220 is assembled, thus preventing central spring mechanism 226 from being positioned incorrectly within upper body 222 and lower body 224.

FIG. 11 is intended to illustrate how the different components of a claimed torque wrench, such as torque wrenches 100 and 220, are assembled. When assembled, ratchet wheel 228 fits within a ratchet wheel opening 234 in central spring mechanism 226. In a similar fashion, torque wheel 232 fits within a torque wheel opening 236 in central spring mechanism 226. Central spring mechanism 226, including ratchet wheel 234 and torque wheel 232 are then enclosed within upper body 222 and lower body 224. Upper body 222 and lower body 224 may then be secured together with glue, snaps, screws, rivets or any other means that may be apparent to hose with skill in the relevant arts (see 116, FIG. 2).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. An apparatus for applying a specific amount of torque to a fastener, comprising:
a body;
a torque wheel, rotationally affixed to the body, comprising a plurality of teeth around an outer edge; and
a central spring mechanism affixed to and enclosed within the body, the central spring mechanism, comprising:
a spring stop; and
a torque spring comprising a torque spring end wherein the torque spring end engages the plurality of teeth;
wherein, in a first rotational direction, the engagement of the torque spring end in the plurality of teeth prevents the torque wheel from rotating with respect to the body below a specified amount of torque; and
wherein, above the specified amount of torque in a second rotational direction that is the opposite of the first rotational direction, the torque spring flexes between the spring stop and a point at which the torque spring attaches to a remainder of the central spring mechanism, enabling the torque spring end to disengage from the plurality of teeth and enabling the torque wheel to rotate with respect to the body.

2. The apparatus of claim 1, further comprising:
a ratchet wheel, rotationally affixed to the body, comprising a second plurality of teeth around a second outer edge; and
a ratchet spring; and
the central spring mechanism, further comprising a ratchet spring comprising a ratchet spring end wherein the ratchet spring end engages the second plurality of teeth;
wherein, in a third rotational direction, the engagement of the ratchet spring end in the second plurality of teeth prevents the ratchet wheel from rotating with respect to the body; and
wherein, in a fourth rotational direction that is the opposite of the third rotational direction, the ratchet spring flexes, enabling the ratchet spring end to disengage from the second plurality of teeth and enabling the ratchet wheel to rotate with respect to the body.

3. The apparatus of claim 1, the torque wheel further comprising a drive hole.

4. The apparatus of claim 3, wherein the drive hole is selected from a group consisting of:
a square drive;
a hexagonal drive; and
a star drive.

5. The apparatus of claim 1, wherein the central spring is constructed of metal.

6. The apparatus of claim 1, wherein the central spring is constructed of plastic.

7. A torque wrench, comprising:
a body;
a central spring mechanism affixed to and enclosed within the body, the central spring mechanism, comprising:
a spring stop; and
a torque spring comprising a torque spring end;
a torque wheel, enclosed within the body and within an opening in the central spring body, comprising a plurality of teeth around an outer edge; wherein the torque spring end engages the plurality of teeth;
wherein, in a first rotational direction, the engagement of the torque spring end in the plurality of teeth prevents the torque wheel from rotating with respect to the body below a specified amount of torque; and
wherein, above the specified amount of torque in a second rotational direction that is the opposite of the first rotational direction, the torque spring flexes between the spring stop and a point at which the torque spring attaches to a remainder of the central spring mechanism, enabling the torque spring end to disengage from the plurality of teeth and enabling the torque wheel to rotate with respect to the body.

8. The torque wrench of claim 7, further comprising:
a ratchet wheel, enclosed within the body and within a second opening in the central spring body, comprising a second plurality of teeth around a second outer edge; and
a ratchet spring; and
the central spring mechanism, further comprising a ratchet spring comprising a ratchet spring end wherein the ratchet spring end engages the second plurality of teeth;
wherein, in a third rotational direction, the engagement of the ratchet spring end in the second plurality of teeth prevents the ratchet wheel from rotating with respect to the body; and
wherein, in a fourth rotational direction that is the opposite of the third rotational direction, the ratchet spring flexes, enabling the ratchet spring end to disengage from the second plurality of teeth and enabling the ratchet wheel to rotate with respect to the body.

9. The torque wrench of claim 7, the torque wheel further comprising a drive hole.

10. The torque wrench of claim 9, wherein the drive hole is selected from a group consisting of:
a square drive;
a hexagonal drive; and
a star drive.

11. The torque wrench of claim 7, wherein the central spring is constructed of metal.

12. The torque wrench of claim 7, wherein the central spring is constructed of plastic.
